(19) United States
(12) Patent Application Publication
(10) Pub. No.: US 2020/0021131 A1
(43) Pub. Date: Jan. 16, 2020

(54) CONTROL FOR ENERGY RESOURCES IN A MICROGRID

(71) Applicant: Battelle Memorial Institute, Richland, WA (US)

(72) Inventors: Kevin P. Schneider, Seattle, WA (US); Francis K. Tuffner, Richland, WA (US); Yingying Tang, Richland, WA (US); Nikitha Radhakrishnan, Richland, WA (US); Priya Thekkumparambath Mana, Richland, WA (US)

(73) Assignee: Battelle Memorial Institute, Richland, WA (US)

(21) Appl. No.: 16/036,799

(22) Filed: Jul. 16, 2018

(51) Int. Cl. H02J 13/00; H02J 3/38

(52) U.S. Cl. CPC H02J 13/001; H02J 3/386; H02J 3/383; H02J 2003/007; H02J 13/002; H02J 2003/388; H02J 3/387

(57) ABSTRACT

A method employing an intuitive physical slider, or graphical computer display of a slider, to generate a single input value for use in generating operating set points (typically comprising dispatch and droop settings) for each of a multiplicity of energy resources in a microgrid to achieve a predetermined operational goal, such as maximizing resiliency or efficiency, or minimizing emissions. The single input value may be selected to maximize the resiliency of the microgrid, using a minimized droop when the microgrid encounters either a decrease in energy resources or an abrupt increase in end-user loads. Alternatively, the single input value may maximize the efficiency of the microgrid. Other operational goals may also be achieved with different settings of the single input value.

### ACKNOWLEDGMENT OF GOVERNMENT SUPPORT

This disclosure was made with Government support under Contract DE-AC05-76RL01830 awarded by the U.S. Department of Energy. The Government has certain rights in the invention.

### FIELD

This application relates generally to the control of energy resources in microgrids.

### BACKGROUND

A microgrid is defined as a group of interconnected (end-use) loads and distributed energy resources (DERs) (energy sources) within defined electrical boundaries that acts as a single controllable entity with respect to the grid. A microgrid may be connected to, and operate synchronously with, a traditional centralized electric grid (the macrogrid). When connected to the macrogrid, some energy resources within the microgrid, such as diesel generators, may be in stand-by mode. Renewable energy resources, such as photovoltaic arrays or windmills, may continue to generate power at varying levels during the day, although possibly not at levels to completely address power needs within the microgrid. Still other energy resources, such as fuel cells or battery arrays, may be recharged using both power from the macrogrid as well as the renewable resources. In some circumstances, such as when the macrogrid experiences an outage, the microgrid may be disconnected from the macrogrid, operating in an isolated islanded mode. Neighboring microgrids may have circuit breaker connections linking between them, enabling multiple microgrids to (optionally) support each other's operations especially during periods in which they are collectively islanded.

With the increasing interest in deploying microgrids as resiliency resources arising from concerns about system robustness, efforts to optimize the microgrid sectors of the power system are also now experiencing increased interest. In particular, with increasing microgrid use in islanded modes, operational factors in addition to resiliency, such as efficiency and lowered emissions, are receiving increased attention. As in nearly any multi-parameter optimization, trade-offs between operating parameters arise. Merely maximizing resiliency (typically characterized by reducing the frequency droop resulting from either a decrease in energy resources or an abrupt increase in end-use loads) may result in poor efficiency and/or excessively high emissions (e.g., from diesel generators). Since trade-offs are nearly inevitable, some means of easily moving between operating modes emphasizing resiliency to operating modes emphasizing efficiency or lowered emissions, would be desirable.

### SUMMARY

A User Interface (UI) element (e.g., a physical slider, or graphical computer display of a slider) is disclosed to generate a single input value for use in generating operating set points for each of a multiplicity of energy resources in a microgrid in order to achieve a predefined operational goal, such as maximizing resiliency or efficiency, or minimizing emissions. The single input value may be selected to maximize the resiliency of the microgrid, using a minimized droop when the microgrid encounters either a decrease in energy resources or an abrupt increase in end-user loads. The single input value may alternatively maximize the efficiency of the microgrid. Other operational goals may also be achieved with different settings of the single input value.

The foregoing and other objects, features, and advantages of the invention will become more apparent from the following detailed description, which proceeds with reference to the accompanying figures.

### BRIEF DESCRIPTION OF THE DRAWINGS

FIG. 1 is a schematic diagram of a microgrid.

FIG. 2 is an illustration of a two-parameter optimization slider.

FIG. 3 is an illustration of a three-parameter optimization slider.

FIG. 4 is a graph of minimum frequency values for different generator set points.

FIG. 5 is a graph of efficiency curves for a diesel generating unit and an inverter.

FIG. 6 is a flowchart of an embodiment of a process for controlling energy resources in a microgrid.

FIG. 7 is a flowchart of an embodiment of a process for controlling energy resources in a microgrid.

FIG. 8 is a flowchart of an embodiment of a process for controlling energy resources in a microgrid.

FIG. 9 is a one-line diagram of the modified IEEE 123 node test system.

FIG. 10 is a table of optimized generator set points for various slider settings.

FIG. 11 is a graph of resiliency and efficiency for various slider settings for a planned event.

FIG. 12 is a graph of resiliency and efficiency for various slider settings for a given load step at multiple system locations.

FIG. 13 is a graph of resiliency and efficiency for various slider settings for multiple values of a step load increase.

FIG. 14 is a graph of resiliency and efficiency for various slider settings for the loss of a generator in the test system.

FIG. 15 is an example computer environment that can be used to implement the embodiments described herein.

### DETAILED DESCRIPTION

Schematic Illustration of a Microgrid

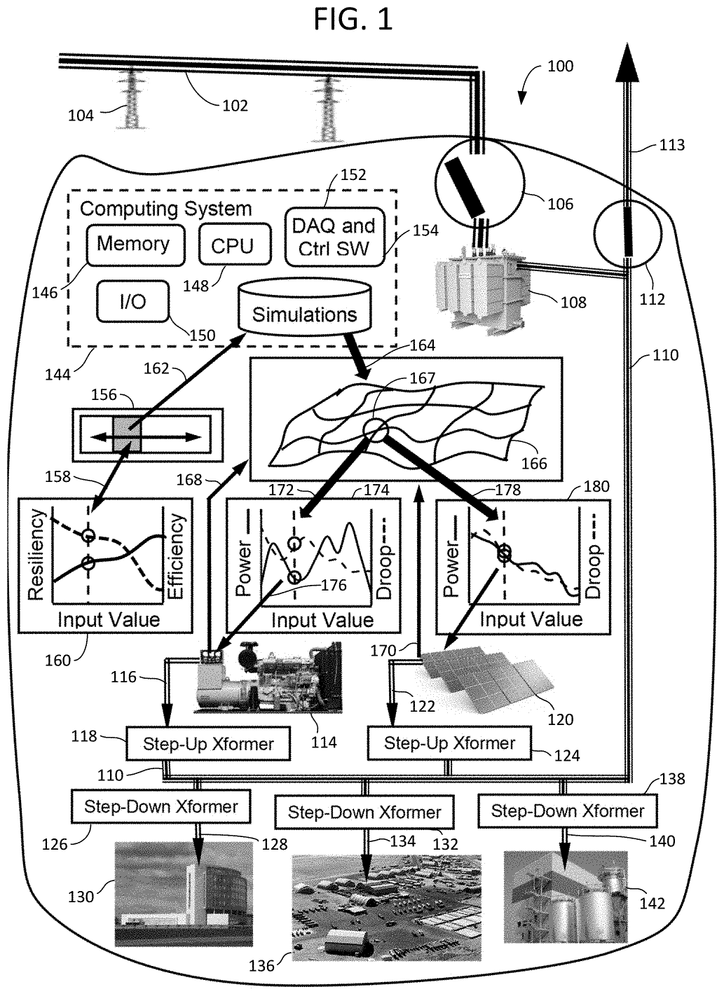

FIG. 1 is a schematic diagram of a microgrid 100. Transmission line 102 supported by towers 104 connects into the primary distribution line 110 of microgrid 100 through circuit breaker 106. In the most common situation in which the microgrid is receiving power from the macrogrid through transmission line 102, transformer 108 operates in step-down mode, lowering the voltage from a typical range of around 38 kV down to the primary distribution voltages typical within a microgrid in range of 208/480 V or up to ˜4200 V. In a situation where the microgrid is supplying power out to the macrogrid, this situation is reversed and transformer 108 operates in a step-up mode with a power flow out from primary distribution line 110 through transformer 108 to transmission line 102. A third situation occurs when microgrid is islanded and circuit breaker 106 is open (as illustrated in FIG. 1)—in this case, microgrid may be completely isolated from the macrogrid and from other microgrids if circuit breaker 112 were also open (shown closed in FIG. 1), or microgrid 100 could be interconnected to one or more neighboring microgrids through line 113, which may typically be at the primary distribution voltage internal to microgrid 100. If microgrid 100 is interconnected to neighboring microgrids through line 113, these networked microgrids may also be connected to the macrogrid and either receiving power from the macrogrid or transmitting power out to the macrogrid (i.e., even if circuit breaker 106 is open, if circuit breaker 113 is closed then microgrid 100 may be receiving power from, or sending power to, the macrogrid indirectly through another microgrid).

Primary distribution line 110 distributes power within microgrid 100, but at too high of a voltage for safe use within user facilities served by the microgrid and also above the typical voltages generated by energy resources within the microgrid, such as diesel generators or inverters. Thus, for example, a hospital 130 receives power typically in the 120-480 V range through line 128 from step-down transformer 126, while a military base 136 receives lower voltage power through line 134 from step-down transformer 132, while a factory 142 receives lower voltage power through line 140 from step-down transformer 138.

Similar voltage considerations apply to various energy resources within microgrid 100. Diesel generator 114 may typically generate power in the 110-480 V range which is transmitted through line 116 to step-up transformer 118 to be supplied to primary distribution line 110. Similarly, photovoltaic (PV or solar cell) array 120 may typically generate very low voltage DC power which is converted to AC power by an inverter (not shown) which conveys this power (which is still at a lower voltage than primary distribution line 110) through line 122 to step-up transformer 124. Another type of energy resource (not shown) of increasing importance is battery storage. Battery storage also can employ an inverter to provide AC power into primary distribution line 110, also typically through a step-up transformer.

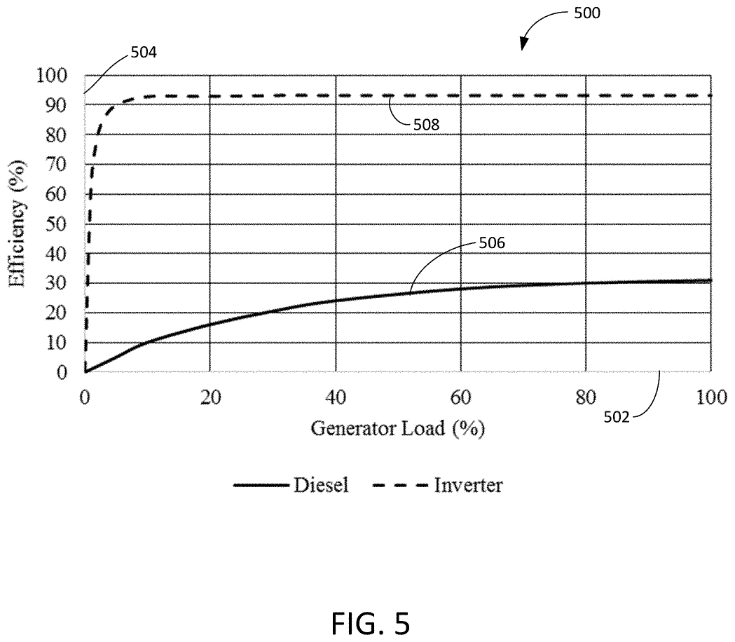

Each type of energy resource has its own advantages and disadvantages. Typically, a microgrid may combine multiple types of energy resources to achieve an optimum mix of resiliency, efficiency, and possibly lower emissions, or other desirable operating characteristics. Diesel generators are typically relatively cost-effective due to the maturity and simplicity of the technology. When needed, a diesel generator may typically come on-line within a few seconds, assuming proper maintenance has been performed. Diesel generators may operate at high power levels for extended periods, continually and with minimal supervision. A disadvantage of diesel generators is substantially lowered efficiencies when operating at reduced loads (see curve 506 in FIG. 5). At loads below 50-60%, wet stacking occurs in which diesel engines running at reduced loads fail to completely burn their fuel, with the undesirable result of unburned fuel being emitted out the exhaust thereby reducing efficiency. Photovoltaic (PV) energy resources have their own limitations, among them being no power capabilities at night, and reduced power capabilities in cloudy, rainy, or snowy conditions. Although some of these PV limitations are predictable (i.e., night), other limitations (periodic clouds passing overhead) may be unpredictable and occurring with a rapid onset and passing. Windmill energy resources have similar limitations to PV arrays—power levels may vary suddenly and unpredictably over the period of a day. Battery energy resources have the advantage of very rapid ramp-up and potentially large capacity to bridge over macrogrid drop-outs. Costs for large-scale battery-based energy resources are currently dropping thanks to economies of scale in Li-ion battery manufacturing. A disadvantage of battery arrays is that they do not generate power and must be charged by another energy resource prior to use. Power resources within a microgrid may comprise one or more of the following: generators (diesel-powered, gasoline-powered, etc.), and inverter-based resources such as batteries, windmills, fuel cells, microturbines, and solar panels. The energy resources have in common that they are capable of supplying energy to a load. Control of energy resources in a microgrid currently operates at multiple overlapping levels, primary, secondary and tertiary, as discussed below. Typically, multiple types of the energy resources are used simultaneously to produce power to the primary distribution line 110 in the microgrid.

Computer system 144 may be pre-existing in microgrid 100 to implement levels of secondary and tertiary control, or computer system 144 may be added to microgrid 100 to implement embodiments operating above these pre-existing control levels. Computing system 144 may comprise a central processing unit (CPU) 148 for executing data acquisition (DAQ) and control software 152 stored in memory 146 and/or non-volatile storage media 154. Interaction with the microgrid and system operators may be effected through input/output (I/O) subsystem 150.

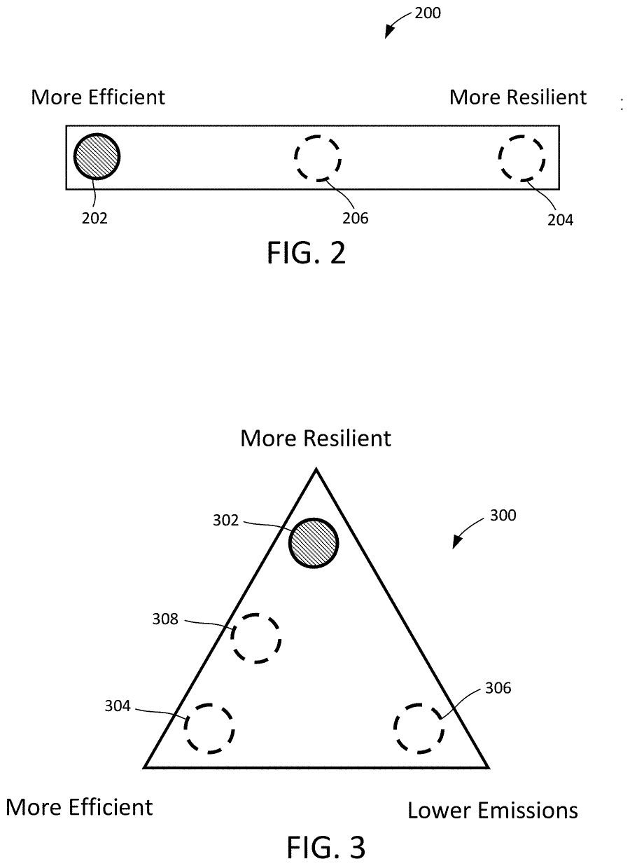

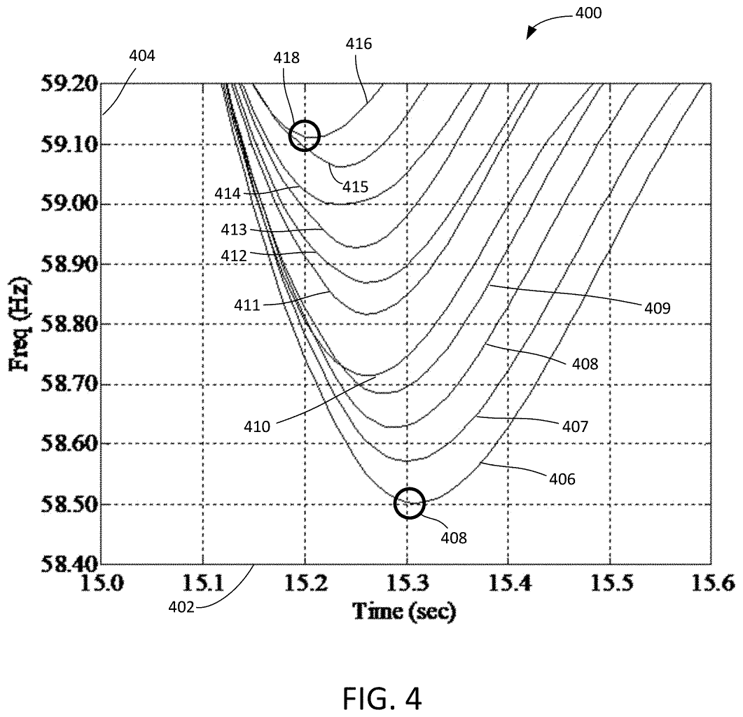

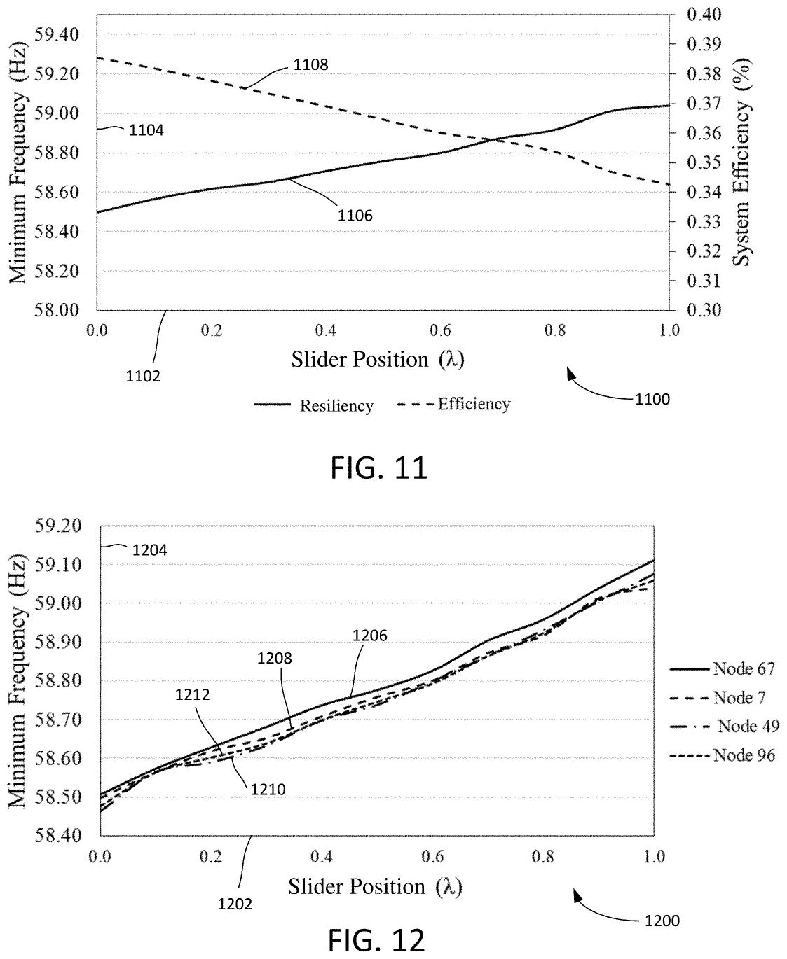

A slider 156 can be used as a single point of control of multiple energy resources that are adjusted simultaneously. Further details of the operation of slider 156 are provided in FIG. 2, below. A system operator may move slider 156 to the far right to maximize the resiliency of microgrid (solid line curve in graph 160)—in the context of some embodiments, resiliency is characterized by minimizing droop (e.g., selecting curve 416 instead of curve 406 in FIG. 4). This characterization is based on the observation that for deeper droop values (i.e., a minimum 408 at 58.5 Hz compared with a minimum 418 at ˜59.11 Hz) there is an increased likelihood of an overall collapse of the microgrid. Maintaining reduced droop levels minimizes this risk, however possibly at the cost of reduced energy efficiency—thus the need for a slider to enable system operators to trade-off these two operating goals. A system operator may move slider 156 to the far left to maximize the efficiency of the microgrid (dashed line curve in graph 160). Graph 160 is a schematic representation of FIG. 11. The single input value along the horizontal axis may vary from maximized efficiency at the far left to maximized resiliency at the far right. The dashed vertical line on graph 160 represents the position of slider 156 mapped (arrow 158) onto the input value axis—the two circles show the intersections of the solid and dashed lines which determine the resiliency and efficiency values for this particular setting of slider 156. As shown, slider 156 is selecting relatively high (but not maximized) levels of efficiency but still with as much resiliency as possible. In embodiments, a system operator may observe a display of graph 160 as a guide to positioning slider 156. In embodiments, a system operator may set a position of slider 156 based on other considerations with or without a display of graph 160. In embodiments, a system operator may position slider 156 based on both graph 160 and other considerations. In embodiments, slider 156 may be positioned by an algorithm executing on a computer or other microgrid control system, typically with non-real time inputs to the algorithm from a system operator.

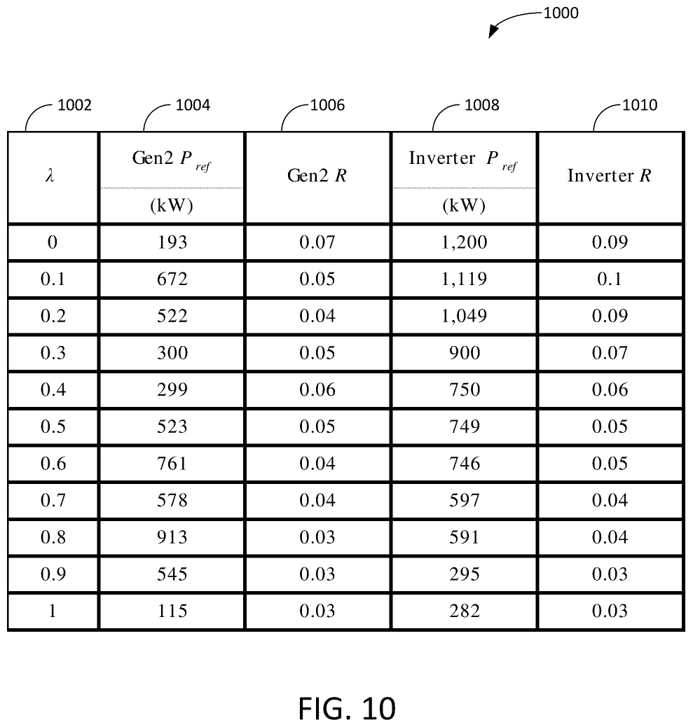

Graph 174 represents typical curves (data from table 1000 in FIG. 10) of the control parameters power (dispatch) and droop as functions of the single input value for a diesel generator showing maximized efficiency at the far left and maximized resiliency at the far right. Based on the position of the slider 156, the vertical dashed line intersects the resiliency and efficiency curves at the two circles shown—these circles represent the control parameters to be supplied to diesel generator 114 (arrow 176). Graph 180 represents typical curves (data from table 1000 in FIG. 10) of the control parameters power (dispatch) and droop as functions of the single input value for an inverter at the output of a photovoltaic array 120, e.g., showing maximized efficiency at the far left and maximized resiliency at the far right. Based on the position of the slider 156, the vertical dashed line intersects the resiliency and efficiency curves at the two circles shown—these circles represent the control parameters to be supplied to the inverter on PV array 120 (arrow 182).

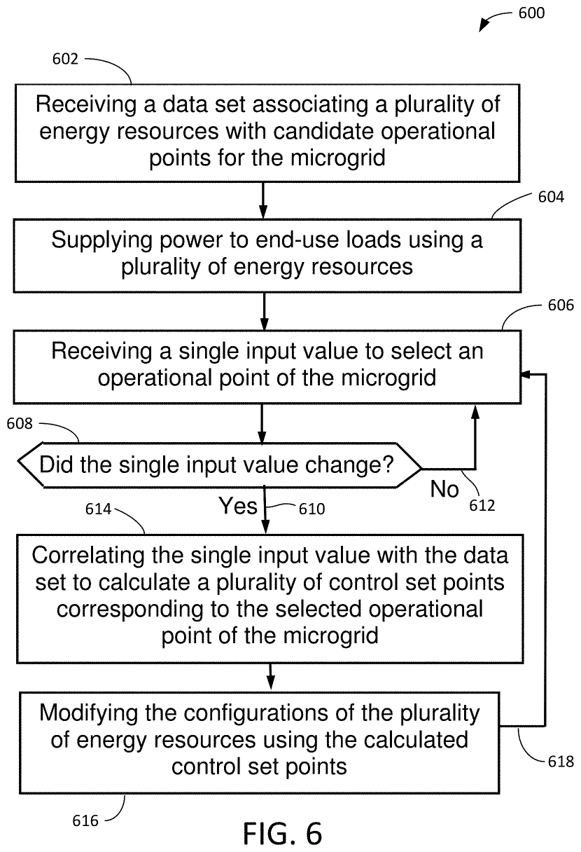

Given a setting for slider 156, FIGS. 6-8 show flowcharts for embodiments of methods for control of grid energy resources. The overall process flow in FIG. 1 is included in the discussions of FIGS. 6-8, below.

### Sliders for Control of Two or More Parameter Optimizations

FIG. 2 illustrates schematically a two-parameter slider 200 operable to enable a system operator to optimize a balance between two microgrid operating characteristics: more resilient and more efficient. The slider may be a physical device which is mechanically movable along a horizontal direction in the plane of FIG. 2, wherein, for example, motion towards the left increases the efficiency of the system while possibly reducing the resiliency of the system. Motion of the slider to the far left (position 202) produces the most efficient system—the meaning of most efficient will be discussed below. Motion of the slider to the far right (position 204) produces the most resilient system. Positioning of the slider near the center 206 produces a system which balances both resiliency and efficiency. The system operates as resiliently as possible (given the constraint of maximized efficiency) with the slider at position 204, and the system operates as efficiently as possible (given the constraint of maximized resiliency) with the slider at position 202. Thus, the slider 200 represents a continuum of different operational set points for which there are different combinations of control parameters setting the energy resources' operational states.

In some embodiments, slider 200 may be a mechanical structure. In some embodiments, slider 200 may be an icon in a graphic user interface (GUI) on a computer display screen. In some embodiments, slider 200 may have a different structure and/or a different appearance. In some embodiments, the two operating characteristics may differ from one or both of more resilient and more efficient. In some embodiments, the position of the slider may be entered by typing a number, or by selecting a number from a list using an input device, such as a computer mouse, arrow keys, or trackball, etc., wherein a slider position 202 at the far left may correspond to a single input value of 0.0 while a slider position 204 at the far right may correspond to a single input value of 1.0. A slider position at the center 206 may correspond to a single input value of −0.5. In embodiments, a numeric entry (e.g., typed-in or selected from a table) of a single input value may change a position of a slider on a GUI in a slider icon.

FIG. 3 illustrates schematically a three-parameter slider 300 operable to enable a system operator to optimize a balance between three microgrid operating characteristics: more resilient, more efficient, and lower emissions (environmental friendliness, etc.). The slider may be a physical device movable in two directions (left-right and up-down) in the plane of FIG. 3, with a mechanical controller (e.g., a joystick) that may be physically moved left, right, up, or down. Motion of the slider towards a top position 302 selects microgrid operating parameters to make the microgrid more resilient. Motion of the slider towards a lower left position 304 selects microgrid operating parameters to make the microgrid more efficient. Motion of the slider 300 towards a lower right position 306 selects microgrid operating parameters to make the microgrid emit lower levels of harmful emissions (e.g., carbon dioxide, carbon monoxide, nitrous oxides, carbon particulates, etc.). Positioning of the slider near the center 308 along the left side of slider 300 produces a system which balances both resiliency and efficiency, while still maintaining the lowest possible emissions consistent with this balance between resiliency and efficiency. In all cases, all three parameters are balanced against each other and the system operating set points will be determined for overall optimum performance. Different operational set points can be as follows:

1) With the slider at the more resilient position 302, after resiliency has been maximized both efficiency and emissions will be optimized as much as possible.

2) With the slider at the more efficient position 304, after efficiency has been maximized both resiliency and emissions will be optimized as much as possible.

3) With the slider at the lower emissions position 306, after the emissions have been minimized both resiliency and efficiency will be optimized as much as possible.

4) With the slider mid-way between the more efficient and more resilient positions at position 308, after the efficiency and resiliency have been simultaneously maximized emissions will be optimized as much as possible.

In some embodiments, slider 300 may be a mechanical structure. In some embodiments, slider 300 may be a UI element in a graphic user interface (GUI) on a computer display screen. In some embodiments, slider 300 may have a different structure and/or a different appearance. In some embodiments, slider 300 may be on a computer display screen wherein the position of slider 300 may be determined by: 1) a system operator, 2) an algorithm running on a system control computer, or 3) both a system operator (where the slider is displayed on a screen and moved by a computer mouse, etc.) and an algorithm (where the slider displays the input value determined by the algorithm). In some embodiments, the three operating characteristics may differ from those shown in FIG. 3: more resilient, more efficient, and lower emissions. In some embodiments, the position of the slider may be entered by typing one or more numbers, and/or by selecting one or more numbers from a list. One number, possibly entered into a first box on a screen may correspond to a position horizontally (similar to the situation for FIG. 2). Another number, possibly entered into a second box on the screen may correspond to a position vertically. For a two-axis slider, three values (λᵣₑₛ, λ_{eff}, and λₑₘᵢₛₛ) may represent the desired levels of optimization for the three operating parameters: resilience (λᵣₑₛ), efficiency (λ_{eff}), and emissions (λₑₘᵢₛₛ), where in some examples, λᵣₑₛ+λ_{eff}+λₑₘᵢₛₛ=1.0 and 0.0≤λᵣₑₛ, λ_{eff}, λₑₘᵢₛₛ≤1.0. The two numbers specifying the slider position may be considered a single input value for the purposes of embodiments, where the single input value may define a single coordinate, or vector, in a multi-dimensional parameter space (e.g., in FIG. 3, the three dimensions could be efficiency, resiliency, and emissions, the limitation that λᵣₑₛ+λ_{eff}+λₑₘᵢₛₛ=1.0 means that the optimization comprises a two-dimensional spherical surface having a radius of 1.0 in the positive octant of the three-dimensional parameter space).

Control of any numbers of operating parameters larger than three is also possible. For example, some embodiments may comprise four, five, or more operating parameters. Selection of a subset of one, two, or more, of these parameters for simultaneous maximization may be effected using sliders similar to those illustrated in FIGS. 2 and 3. For example, a square (two-dimensional) slider having an operating goal at each corner may enable selection of multiple parameters (with some limitations). Higher-dimensional virtual sliders may be displayed on a computer screen in which multiple parameters are located at individual corners. An example of this might be a three-dimensional tetrahedron having four corners corresponding to four operating parameters (one at each corner) and a three-dimensional slider movable using a computer mouse or keyboard. An output of any type of slider, applied to the control of any number of operating parameters, may be a single input value (vector) as shown in blocks 606, 708, and 810, in FIGS. 6-8, respectively. Whatever slider is used, the computing system corresponds the slider position to a point on the simulation curve 166 so as to extract operating set points for multiple energy resources.

### Multiple Levels of Control in a Microgrid

Control of energy resources in a microgrid currently operates at multiple overlapping levels:

1) Primary Control (time frame sub-seconds to seconds)—this is the real-time level of control currently implemented widely using methods such as to regulate the voltage, line frequency and phase in response to rapid (sub-second) changes in line frequency arising from temporary imbalances between power demand and power supply. FIG. 4 illustrates typical droop curves, which characterize a system response to an abrupt change in power due to an abrupt loss of an energy resource or an abrupt addition of an end-use load (these changes may be either planned or unexpected). Various droop curves ranging from a less resilient energy resource 406 (with a maximum droop 408 of 1.5 Hz down to a minimum frequency of 58.5 Hz) to a highly resilient energy resource 416 (with a maximum droop 418 of only ˜0.89 Hz down to a minimum frequency of ˜59.11 Hz, much closer to 60 Hz) are selected by secondary or tertiary controls and/or by embodiments—then the system will follow the selected curve operating under primary control. The degree of droop may be determined by settings of the speed governor or other controls of a diesel generator, for example, or within the DC to AC conversion performed by the inverter.

2) Secondary Control (time frame, seconds to minutes)—these controls typically operate not in real-time to select the resilience of an energy resource when responding under primary control. One example may be to determine an acceptable level of droop as shown in FIG. 4—choosing a priori (i.e., before the occurrence of a drop-out) how much droop is acceptable for any particular energy resource corresponds to selecting the particular droop curve, ranging from curve 406 up to curve 416. These controls may also specify other operating parameters for diesel generator energy resources. For photovoltaic energy resources, similar considerations apply especially for PV resources connected to the primary distribution line 110 through non-grid forming inverters. These types of inverters may demonstrate similar droop curves to FIG. 4 since they lack the stiffness of grid-forming inverters. Secondary and tertiary controls may determine various aspects of PV, battery, and PV plus battery, energy resource operation under primary control. The secondary control typically takes up where the primary control leaves off in order to restore the microgrid voltage and frequency back to nominal values (while operating with a lower bandwidth and slower response time than the primary controls).

Tertiary Control (minutes to hours)—this level of control may address economic concerns of microgrid operation, including power flows through circuit breaker 106 between the macrogrid and microgrid. Given the longer time frame for tertiary control, factors such as weather (affecting both power line losses and demand for power), grid tariffs, and predicted loads (with a known typical daily fluctuation). Generator dispatches may be tailored to maximize efficiencies while still satisfying power demands. Tertiary control may also address (optional) microgrid interconnections (such as circuit breaker 112) to manage neighboring microgrids—called microgrid clustering or microgrid networking to provide essentially a virtual power plant for maintaining operation of at least the critical loads within respective microgrids. In third-world countries, tertiary control may also monitor and detect non-technical loss (NTL), resulting from theft of electrical wiring (especially copper) and equipment.

Control Employing Embodiments—The control methods in flowcharts 600-800 may be implemented in parallel with the primary, secondary and tertiary controls discussed above.

### Developing a Resiliency Representation for the Microgrid

FIG. 4 is a graph 400 of frequency values (Hz) 404 as a function of time (s) 402 for droop curves corresponding to different generator set points for a 30% step increase in load. The data for the eleven droop curves 406-416 is generated from link 168 in FIG. 1, in which diesel generator 114 is used to measure various droop curves for later use in determining operating points of energy resources to accomplish various operating goals, such as maximizing resiliency, or maximizing efficiency. Droop curves 406-416 may be determined from either simulations and/or an actual diesel generator in a microgrid. Curve 406 has lowest resiliency since a frequency droop of −1.5 Hz (circle 408) is large and extends for a substantial amount of time (note that the top of axis 404 is only 59.20 Hz, already down by 0.8 Hz from the nominal 60 Hz line frequency). Curve 416 has the highest resiliency with a maximum droop of ˜0.89 Hz (circle 418) down to ˜59.11 Hz (from 60 Hz nominal). The nine droop curves 407-415 in between have resiliencies better than curve 406 but worse than curve 416.

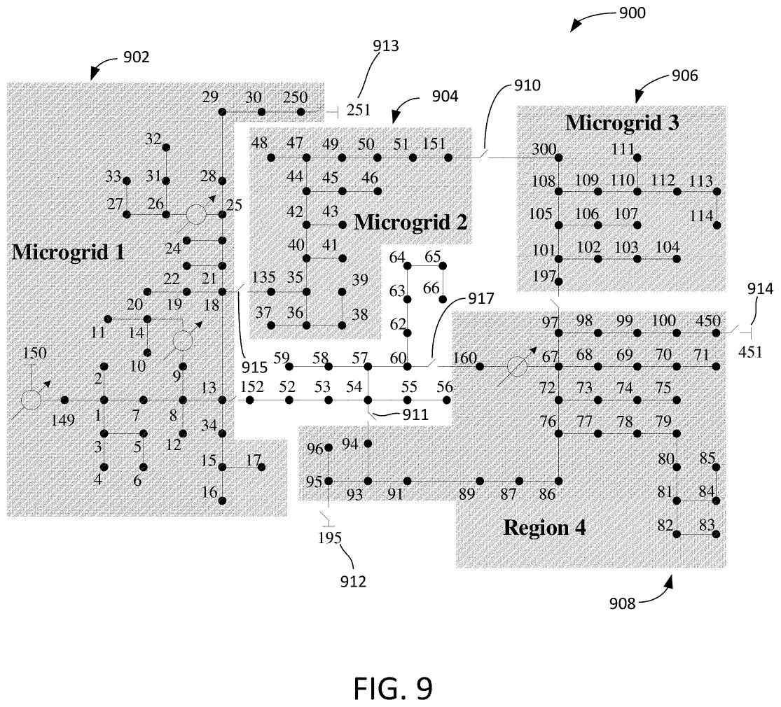

The frequency droops illustrated in FIG. 4 are the result of simulations of a microgrid performed in a computing environment capable of unbalanced simulations of large-size systems (see FIG. 9). For the droop curves 406-416 in FIG. 4, the dispatch and droop values of each power resource are varied, but the assumed 30% step increase in load is the same. Since microgrids are so much smaller than a typical macrogrid, each power resource within a microgrid may typically represent a much larger fraction of the entire microgrid power generation capacity, thus loss of even a single power resource (diesel generator, PV array, windmill, battery, etc.) may have a much larger percentage effect on the microgrid, leading to larger percentage droops as shown in FIG. 4. Similar considerations may apply for the end-use loads (either abruptly dropping out or being abruptly added) within a microgrid. As a result of these considerations, and the proportionately larger frequency variations that are found in microgrids, embodiments employ frequency deviations as a measure of microgrid resiliency—larger variations (either plus or minus away from line frequency) indicate lower resiliency, and smaller variations higher resiliency. Each droop curve 406-416 has a generally downward pseudo-parabolic shape with a minimum frequency value (maximum droop away from the nominal line frequency, 60 Hz). These minimum frequency values may be employed as a single number for quantifying the resiliency of each energy resource configuration (dispatch and droop settings).

Similar types of droop curves may be obtained from link 170 in FIG. 1, wherein photovoltaic array 120 and its associated inverter (not shown—assumed to be non-grid forming) could be used to measure or simulate droop curves (similar in appearance to curves 406-416) for later use in determining operating points of energy resources to accomplish various operating goals, such as maximizing resiliency or maximizing efficiency.

### Developing an Efficiency Representation for the Microgrid

FIG. 5 is a graph 500 of efficiency curves for a diesel generating unit 506 and an inverter 508, showing efficiency (%) 504 as a function of generator load (%) 502. Graph 500 shows that for both diesel generators and inverters, efficiencies (quantified as a percentage of the maximum possible kW output compared to the input energy source [e.g., diesel fuel or solar irradiance]) monotonically increase as the generator load is increased from 0% to 100%. Also apparent is that curve 508 for the inverter rapidly achieves an asymptotic efficiency of ˜93% when the generator load has reached only 10%—note that only electrical losses are accounted for with respect to inverters, and other inefficiencies within solar cells and modules of the PV array are not considered since they are not susceptible to control or optimization. In contrast, the diesel generator efficiency continues to rise all the way to 100% generator load, never going much above 30%, principally due to diesel engine inefficiencies. Clearly, based on efficiency considerations, maximal use of renewable, battery, and fuel cell power resources (all employing inverters) may maximize efficiency of the microgrid, all other things being equal. Conversely, a diesel generator, being available within seconds to provide any power level up to 100% for 24 hours a day over an indefinite period, may represent maximized resiliency in view of the limitations of renewable power resources (PV arrays, windmills) and batteries discussed above for FIG. 1.

As was the case for the determination of the resiliency curves in FIG. 4, individual power resources in the microgrid are interrogated through link 168 (diesel generator 114) and link 170 (PV array 120) for various generator load percentages from 0% to 100% and the power outputs determined. Although links 168 and 170 are shown as going into the simulations, raw data is used by the computing system 144 in order to generate the simulations. Comparison with the nameplate ratings (i.e., the power levels that can nominally be provided by these energy resources), the efficiency curves 506 (diesel generator) and 508 (inverter) may be determined. For ease of use in analysis and optimization, curve fitting formulas may be employed to fit formulas to the efficiency curves. The total microgrid system efficiency is the weighted (where the weight is the ratio of the apparent power of each generator divided by the total apparent power of the microgrid) sum of the efficiencies of all energy resources within the microgrid.

### An Embodiment Determining Set Points Based on the Slider Setting

FIG. 6 is a flowchart 600 of an embodiment of a process for controlling energy resources in a microgrid.

In block 602, a data set is received to associate a plurality of energy resources with candidate operational points for the microgrid. The data set can be generated using graph data, such as graph 400, for each of the energy resources in the microgrid. The data is termed a resiliency representation with curves for a wide range of dispatch and droop settings, ideally fully encompassing the range of these settings expected to occur during operation of the microgrid, thereby enabling interpolation between droop curves to generate all candidate operating set points for dispatch and droop values. The data set can further be generated using graphs, such as graph 500, for each of the energy resources in the microgrid. These graphs are termed an efficiency representation, ideally fully encompassing the range of these settings expected to occur during operation of the microgrid, thereby enabling interpolation between efficiency curves for generator load values.

The data set is the result of simulations and can be generated either in real time during different points of the method 600 or off-line before the method 600 initiates. In some embodiments, the simulations can determine the efficiency and resiliency (as determined by the response to a transient, i.e., the droop curve) at a given operating point of the microgrid. The simulations represent a multi-dimensional surface (see FIG. 1 at 166) over which the optimization may be performed. In FIG. 1, this process is shown by arrow 164, leading from the simulation data stored in storage device 154 to an operating surface 166, which is shown in only three-dimensions for clarity. Operating surface 166 is generated by performing a number of dynamic simulations of the microgrid for various candidate operational points. Each candidate operational point corresponds to a plurality of control set points for the energy resources (i.e., the dispatch and droop settings for each of the energy resources in the microgrid). For each group of set points, the frequency response and system efficiency are determined for the microgrid to determine a point on operating surface 166. In this optimization process, it is assumed that one generating unit in the microgrid is operating in isochronous mode to maintain the nominal 60 Hz line frequency, with all other units in the microgrid operating in droop mode (i.e., governed by a curve such as curves 406-416 in graph 400). Thus, the total number of control set points for the microgrid, which can be determined by the position of slider 156, can equal the total number of energy resources (generators, PV arrays, windmills, fuel cells, batteries, etc.) times two (because each resource requires both a dispatch and a droop value) minus one (because the isochronous resource only requires a dispatch value, but not a droop value). The inherent non-linearities of the microgrid system may also affect the total number of control set points. Other factors may reduce the size of the operational data set, involving the realities of a particular microgrid, such as the fact that for most microgrids there are only a few locations where a large step increase in load or a loss of a generator are possible. With small enough microgrids having sufficient electrical stiffness, the operational data set may be determined by considering only a single step increase in load at a single location within the grid (since the stiffness will ensure that the entire microgrid moves nearly in lockstep with the single location). A curve fitting procedure may be employed to ensure that the operational data set has a continuous range of values. This curve fitting procedure develops continuous surfaces for resiliency and efficiency as a function of the set points for the generators. The mathematical result of the curve fitting procedure may be expressed using the following formulas:

η_{TOTAL}=ƒ(Rᵢ,Pᵢ^{ref}),∀ᵢ (eq. 1)

Δƒ_{avg}=g(Rᵢ,Pᵢ^{ref}),∀i (eq. 2)

Where equation 1 is the total system efficiency of the microgrid and equation 2 is the average frequency deviation (corresponding to resiliency).

Block 604 corresponds to microgrid operation (either connected to the macrogrid, clustered with one or more neighboring microgrids, or islanded) under primary, secondary, and tertiary control (see above). In any event, power is initially supplied to end-use loads using a variety of energy resources. The energy resources can be of different types, such as engines, solar, wind, battery, etc. In block 604, the microgrid is currently operating at a given power level.

A single input value is received in block 606. Thus, an operator desires to change the operational settings of the microgrid. In some embodiments, this value may be received from a mechanical slider which may be physically moved by a system operator to select an operational point of the microgrid. In some embodiments, this value may be received from a computing system (such as computing system 144) wherein a slider icon on a display screen enables an operator, using a device such as a computer mouse, to move a virtual slider to select different single input values. In some embodiments, an algorithm may determine a virtual slider setting to define the single input value. Whatever structure is used, the single input value can be a number value (e.g., between −1 and 1). Thus, the system operator can potentially choose any one of a plurality of operating points for the microgrid.

As long as there is no change in a previously-defined single input value, block 608 will cycle back repeatedly through No link 612 to block 606. When a change in the single input value is detected by block 608, Yes link 610 is followed to block 614.

In block 614, the single input value from block 606 is correlated with the data set (arrow 162 in FIG. 1) to calculate a plurality of control set points (one or more set points for each energy resource in the microgrid)—these control set points correspond to the operational point of the microgrid as determined by the input value received in block 606.

Once the single input value has been determined in block 606 and determined in block 608 to have changed from a previous single input value, in block 614 an optimization is conducted to determine updated control set points for the energy resources in the microgrid. The following minimization formula is applied to the results from equations 1 and 2 where different pairs of values from equations 1 and 2 are substituted into equation 3 to find a minimum:

Min{λΔƒ_{avg}−(1−λ)η_{Total}} (eq. 3)

Where λ is the single input value, and 0.0≤λ≤1.0. This minimization is performed under the constraints that the total power from all generators can equal the power demand from all end-users within the microgrid. Qualitatively, this formula minimizes both the frequency deviation (resiliency) and maximizes the total system efficiency. The overall concept is to balance resiliency against efficiency. Similar optimization formulas will apply for other metrics used to characterize the resiliency (i.e., other than the magnitude of the frequency, maximum

Note that in cases where circuit breaker 106 is closed and the microgrid is connected to the macrogrid, the macrogrid may appear as either another energy resource (i.e., power coming into the microgrid from transmission line 102 through step-down transformer 108) or as an end-user (i.e., power going out to the macrogrid through step-up transformer 108 into transmission line 102). In cases where circuit breaker 112 is closed and the microgrid is connected to one or more neighboring microgrids, similar considerations may apply wherein the neighboring microgrid may appear as either another energy resource (i.e., power incoming along line 113) or as an end-user (i.e., power outgoing along line 113). Efficiency is determined by cost factors, thus the polarity of power transfers from either, or both, of the macrogrid and neighboring microgrids may be affected by potential costs for incoming power, or potential income from outgoing power. The optimum location on the multi-dimensional operating surface 166 may be point 167, which then provides the new control set points through arrows 172 and 178 to diesel generator 114 and (the inverter connected to) PV array 120, respectively.

A single input value, λ, equal to 0.0 corresponds to maximized efficiency, with resiliency as a secondary consideration which is optimized as much as possible within the constraint of first maximizing efficiency. A single input value, λ, equal to 1.0 corresponds to maximized resiliency, with efficiency as a secondary consideration which is optimized as much as possible within the constraint of first maximizing resiliency. Values of the single input value, λ, between 0.0 and 1.0 correspond to simultaneous consideration of both resiliency and efficiency, wherein neither aspect may be fully maximized in determining the system operating mode.

After both steps in block 614 have executed, block 616 now modifies the configurations of the plurality of energy resources using the calculated set points from block 614. In FIG. 1, diesel generator 114 receives new dispatch and droop values (arrow 176), and the (non-grid forming) inverter for PV array 120 receives new dispatch and droop values (arrow 182).

After block 616 has reconfigured the microgrid energy resources, link 618 returns to block 606 to await receipt of another single input value.

### Another Embodiment Determining Set Points Based on the Slider Setting

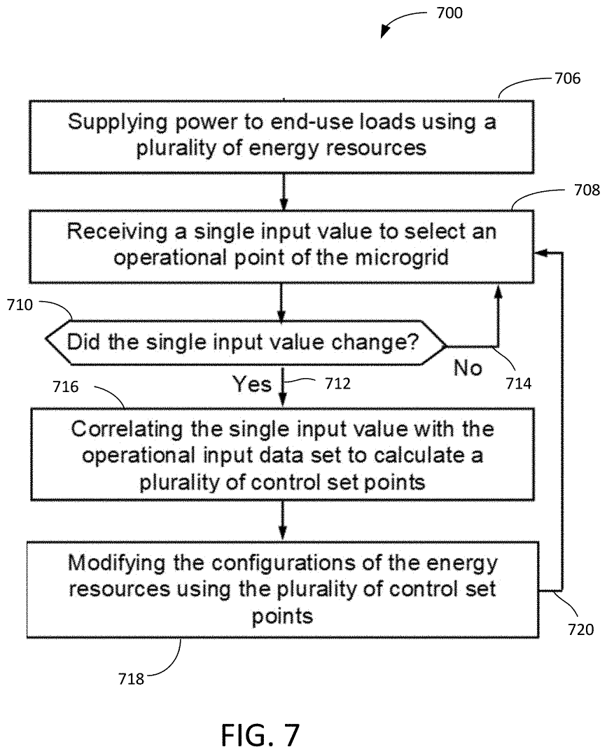

FIG. 7 is a flowchart 700 of another embodiment of a process for controlling energy resources in a microgrid.

In block 706, power is supplied to the microgrid under primary, secondary, and tertiary control (see above).

A single input value is received in block 708. In some embodiments, this value may be received from a mechanical slider, which may be physically moved by a system operator to select an operational point of the microgrid. In some embodiments, this value may be received from a computing system (such as computing system 144) wherein a slider icon on a display screen enables an operator, using arrow keys or an input device, such as a computer mouse, to move a virtual slider to select different single input values. In some embodiments, an algorithm may determine a virtual slider setting to define the single input value. Typically, the single input value is a number, such as a single real number.

As long as there is no change in a previously-defined single input value, block 710 will cycle back repeatedly through No link 714 to block 708. When a change in the single input value is detected by block 710, Yes link 712 is followed to block 716.

In block 716, using the operational surface 166, an optimization is conducted to determine updated control set points for the energy resources in the microgrid. More particularly, the single input value is correlated to the operational surface 166 so as to find a point on the surface corresponding to the input value. Then, control set points of the energy resources are associated with the determined point on the surface 166.

Block 718 now modifies the configurations of the plurality of energy resources using the calculated set points from block 716. In FIG. 1, diesel generator 114 receives new dispatch and droop values (arrow 176), and the (non-grid forming) inverter for PV array 120 receives new dispatch and droop values (arrow 182).

After block 718 has reconfigured the microgrid energy resources, link 720 returns to block 708 to await receipt of another single input value.

### Another Embodiment Determining Set Points Based on the Slider Setting

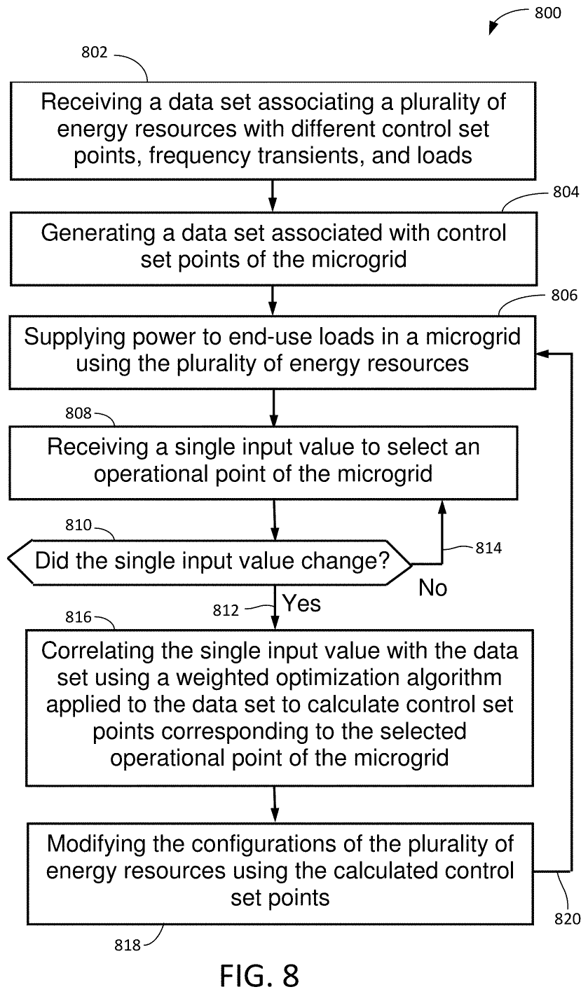

FIG. 8 is a flowchart 800 of another embodiment of a process for controlling energy resources in a microgrid.

In block 802, a data set is received to associate a plurality of energy resources with different control set points, frequency transients, and end-use loads. The portion of this data set comprising graphs such as graph 400 for all the energy resources in the microgrid is termed a resiliency representation with curves for a wide range of dispatch and droop settings, ideally fully encompassing the range of these settings expected to occur during operation of the microgrid, thereby enabling interpolation between droop curves to generate operating set points for dispatch and droop values which were not exactly modeled. The portion of this data set comprising graphs such as graph 500 for all the energy resources in the microgrid is termed an efficiency representation, ideally fully encompassing the range of these settings expected to occur during operation of the microgrid, thereby enabling interpolation between efficiency curves for generator load values which were not exactly modeled.

Once the data sets (representations) have been received in block 802, it is now possible to determine in an off-line process the efficiency and resiliency (as determined by the response to a transient, i.e., the droop curve) at a given operating point. Before block 818 can be performed, it is first necessary to generate a multi-dimensional surface 166 over which the optimization may be performed. Such a determination can be made through simulations. Block 806 corresponds to microgrid operation (either connected to the macrogrid, clustered with one or more neighboring microgrids, or islanded) under primary, secondary, and tertiary control (see above).

A single input value is received in block 808. In some embodiments, this value may be received from a mechanical slider which may be physically moved by a system operator to select an operational point of the microgrid. In some embodiments, this value may be received from a computing system (such as computing system 144) wherein a slider icon on a display screen enables an operator, using arrow keys or a device such as a computer mouse, to move a virtual slider to select different single input values. In some embodiments, an algorithm may determine a virtual slider setting to define the single input value.

As long as there is no change in a previously-defined single input value, block 810 will cycle back repeatedly through No link 814 to block 808. When a change in the single input value is detected by block 810, Yes link 812 is followed to block 816.

Block 816 using the operational surface 166, an optimization is conducted to determine updated control set points for the energy resources in the microgrid. Block 816 can use a weighted optimization algorithm such as the interior-point method, requiring in some cases less than a second of computation time.

Block 818 now modifies the configurations of the plurality of energy resources using the calculated set points from block 816. In FIG. 1, diesel generator 114 receives new dispatch and droop values (arrow 176), and the (non-grid forming) inverter for PV array 120 receives new dispatch and droop values (arrow 182).

In all embodiments, the single input value may be set by a human or a control computer with reference to a single microgrid, which may be islanded or not. The single input value may also be varied (at frequent intervals) by a larger control system to coordinate the operation of networked microgrids, again, either when all the networked microgrids are islanded together or not.

Several factors aid in implementing embodiments:

1) Simulations can be run off-line and simulations can be run in parallel.

2) The large generators within a microgrid can be considered, while smaller generators are ignored, since smaller generators have minimal effects. For example, most microgrids with total capacity under 10 MW have only a few generators greater than 500 kW.

3) Simulations may only need to be run for a step increase in load at a single location within the microgrid.

After block 818 has reconfigured the microgrid energy resources, link 820 returns to block 806 to await receipt of another single input value.

### Aspects of Executing the Methods

FIG. 9 is a one-line diagram 900 of the modified IEEE 123 node test system. Three microgrids 902-906 and region 908 are shown. Circuit breaker 910 connects microgrids 902 and 904. Circuit breaker 915 connects Microgrids 904 and 902. Circuit breakers 911 and 917 connect region 908 to microgrid 902. Incoming transmission lines connect to microgrid 902 at 913, and to region 908 at 912 and 914. Modifications to the standard IEEE 123 node test system include the addition of three generation sources:

1) generator #1—a diesel generator (4 kVA rating—operating in isochronous mode) at node 8 (in microgrid 902),

2) generator #2—a diesel generator (1.5 kVA rating) at node 50 (in microgrid 904), and

3) generator #3—a battery (1.5 kVA rating) at node 54 (outside the microgrids).

In the simulations, the dispatches for generators #2 and #3 are varied from 0.25 to 1.5 MW in steps of 0.25 MW (36 values total) with droop values varying from 0.01 to 0.10 in steps of 0.01 (10 values total). Thus, a total of 3600 simulations are possible to be performed with all circuit breakers closed so that the entire 123 node test system simulated a microgrid, however some of these combinations of. These 3600 simulations were screened for infeasible and invalid conditions, resulting in 2025 valid operating points and conditions for the optimizer to operate on.

Translating Single Input Values into Control Set Points

FIG. 10 is a table 1000 of optimized generator set points 1004-1010 for various slider settings 1002. Column 1002 shows eleven possible values for the single input value, λ, ranging from 0.0 to 1.0 in steps of 0.1. A single input value of 0.0 corresponds to maximum efficiency, while a single input value of 1.0 corresponds to maximum resiliency. Columns 1004 and 1006 provide control set points for a diesel generator, while columns 1008 and 1010 provide control set points for a non-grid forming inverter (connected to a PV array, windmill, fuel cell, battery, etc.). Columns 1004 and 1008 are dispatch values while columns 1006 and 1010 are droop values. Due to inherent non-linearities in the microgrid, there is considerable variation in the dispatch values, especially in column 1004 for diesel generator dispatches.

For single input values, λ, nearer 0 (maximized efficiency) several observations may be made:

1) Dispatch values for the (efficient, non-fuel consuming) inverters are higher, indicating an increased dependence upon the efficient PV arrays, windmills, and fuel cells.

2) Dispatch values for the diesel generator are lower.

3) Droop values are higher for both types of generators, indicating an increased tolerance for frequency deviations (i.e., lower resiliency).

For single input values, λ, nearer 1 (maximized resiliency) several observations may also be made:

1) Dispatch values for the (efficient, non-fuel consuming) inverters are lower, indicating a reduced dependence upon PV arrays, windmills, and fuel cells.

2) Dispatch values for the diesel generator generally trend higher, although with large fluctuations between single input values, λ, differing by only 0.1.

3) Droop values are lower for both types of generators, indicating a reduced tolerance for frequency deviations (i.e., higher resiliency).

### Modeling of the Optimization Process

FIG. 11 is a graph 1100 of resiliency 1106 and efficiency 1108 for various slider settings 1102 for a large step increase in load at node 67 (see FIG. 9). This situation is not uncommon in microgrids having a single large end-use load such as a large pump with an across-the-line controller. In this case, during starting, current loads from the pump electric motor on the primary distribution line 110 may be hundreds of percent of the rated full-load current for the pump motor during steady operation, and thus may present an extremely high momentary load on the microgrid. Execution of any of the flowcharts described above may generate the data for graph 1100 showing resiliency 1106 (plotted against axis 1104) and efficiency (plotted against axis 1110).

As the single input value, λ, is increased from 0.0 towards 1.0, the minimum frequency increases, the resiliency improves (as indicated by reduced droop) at the expense of reduced efficiency—note that embodiments are still optimizing efficiency given the constraint of first maximizing resiliency. Conversely, as the single input value, λ, is decreased from 1.0 towards 0.0, efficiency increases at the expense of reduced resiliency—note that embodiments are still optimizing resiliency given the constraint of first maximizing efficiency.

FIG. 12 is a graph 1200 of resiliency (curves 1206-1212, plotted against axis 1204) for various slider settings 1202 for a given load step at nodes 67, 7, 49, and 96, giving resiliency curves 1206-1212, respectively. The efficiency curves for all four nodes are the same, and match curve 1108 in FIG. 11 since efficiency calculations are performed prior to the transient which generates the frequency droops in FIG. 12. The resiliency data for node 67 is the same as in FIG. 11. The fact that all four curves 1206-1212 cluster together (differences are less than 0.1%) over the full range of the single input value (slider position λ) indicates that as long as the microgrid exhibits sufficient stiffness, then a single operational data set may represent load increases at different locations (in this example, nodes 67, 7, 49, and 96) within the microgrid. As expected, the trend for resiliency shown in all four curves 1206-1212 is similar to that of curve 1106 in FIG. 11.

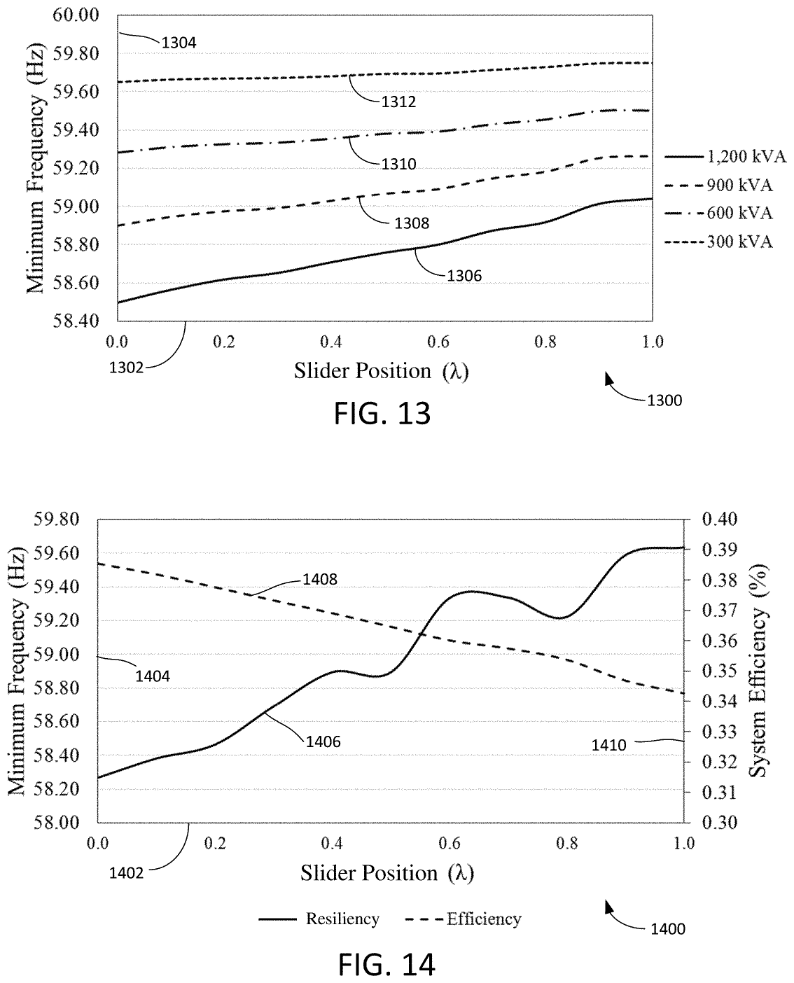

FIG. 13 is a graph 1300 of resiliency (curves 1306-1312 plotted against axis 1304) for various slider settings 1302 for multiple values of a step load increase at node 49. Curves 1306-1312 correspond to step load increases of 1200 kVA, 900 kVA, 600 kVA, and 300 kVA, respectively. As in FIG. 12, the efficiency curves for all four nodes are the same, and match curve 1108 in FIG. 11 since efficiency calculations are performed prior to the step load increases generating curves 1306-1312. All four resiliency curves 1306-1312 demonstrate the same monotonic upward trend for increasing single input values as in FIG. 11.

FIG. 14 is a graph 1400 of resiliency (curve 1406 plotted against axis 1404) and efficiency (curve 1408 plotted against axis 1410) for various slider settings 1402 for the loss of a generator in the test system (FIG. 9).

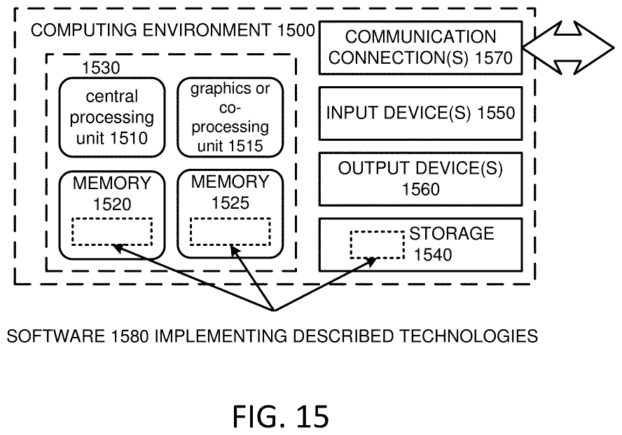

FIG. 15 depicts a generalized example of a suitable computing environment 1500 in which the described innovations may be implemented. The computing environment 1500 is not intended to suggest any limitation as to scope of use or functionality, as the innovations may be implemented in diverse general-purpose or special-purpose computing systems. For example, the computing environment 1500 can be any of a variety of computing devices (e.g., desktop computer, laptop computer, server computer, tablet computer, etc.)

With reference to FIG. 15, the computing environment 1500 includes one or more processing units 1510, 1515 and memory 1520, 1525. In FIG. 15, this basic configuration 1530 is included within a dashed line. The processing units 1510, 1515 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 15 shows a central processing unit 1510 as well as a graphics processing unit or co-processing unit 1515. The tangible memory 1520, 1525 may be volatile memory (e.g., registers, cache, RAM), non-volatile memory (e.g., ROM, EEPROM, flash memory, etc.), or some combination of the two, accessible by the processing unit(s). The memory 1520, 1525 stores software 1580 implementing one or more innovations described herein, in the form of computer-executable instructions suitable for execution by the processing unit(s).

A computing system may have additional features. For example, the computing environment 1500 includes storage 1540, one or more input devices 1550, one or more output devices 1560, and one or more communication connections 1570. An interconnection mechanism (not shown) such as a bus, controller, or network interconnects the components of the computing environment 1500. Typically, operating system software (not shown) provides an operating environment for other software executing in the computing environment 1500, and coordinates activities of the components of the computing environment 1500.

The tangible storage 1540 may be removable or non-removable, and includes magnetic disks, magnetic tapes or cassettes, CD-ROMs, DVDs, or any other medium which can be used to store information in a non-transitory way and which can be accessed within the computing environment 1500. The storage 1540 stores instructions for the software 1580 implementing one or more innovations described herein.

The input device(s) 1550 may be a touch input device such as a keyboard, mouse, pen, or trackball, a voice input device, a scanning device, or another device that provides input to the computing environment 1500. The output device(s) 1560 may be a display, printer, speaker, CD-writer, or another device that provides output from the computing environment 1500.

The communication connection(s) 1570 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or non-volatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only examples of the invention and should not be taken as limiting the scope of the invention. We therefore claim as our invention all that comes within the scope of these claims.

We claim:

1. A method of controlling operating set points of energy resources in a microgrid, comprising:
receiving a data set associating a plurality of energy resources with candidate operational points for the microgrid;
supplying power to end-use loads using the plurality of energy resources;
receiving a single input value to select an operational point of the microgrid;
correlating the single input value with the data set to calculate a plurality of control set points corresponding to the selected operational point of the microgrid; and
modifying the configurations of the plurality of energy resources using the calculated control set points.

2. The method of claim 1, wherein the receiving a data set includes accessing a database of simulations of a plurality of energy resources having different control set points.

3. The method of claim 1, further including simulating a plurality of energy resources having different control set points to generate the data set.

4. The method of claim 3, wherein the simulating of the plurality of energy resources includes simulating the microgrid with different transient conditions.

5. The method of claim 1, wherein the end-use loads are within the microgrid.

6. The method of claim 1, wherein the single input value is received from a user input (UI) element that allows a user to graphically set the operational point of the microgrid.

7. The method of claim 1, wherein each control set point is associated with one of the plurality of energy resources and controls an output of its respective energy resource.

8. The method of claim 1, wherein at least power efficiency and frequency deviation of the plurality of energy resources are weighted differently based on the single input value.

9. The method of claim 1, wherein the calculated control set points identify a power output and a droop value for at least one energy resource of the plurality of energy resources.

10. The method of claim 1, wherein the calculated control set points include voltage control and speed control for at least one of the plurality of energy resources.

11. The method of claim 1, wherein the energy resources include one or more of the following: generators, batteries, windmills, fuel cells, microturbines, and solar panels.

12. The method of claim 1, wherein the correlating the single input value with the data set includes using a weighted optimization algorithm applied to the data set, wherein the single input value determines an input variable into the weighted optimization algorithm.

13. A method of controlling operating set points of energy resources in a microgrid, comprising:
supplying power to end-use loads using a plurality of energy resources;
receiving a single input value to select an operational point of the microgrid;
correlating the single input value with an operational input data set to calculate a plurality of control set points; and
modifying configurations of the plurality of energy resources using the plurality of control set points.

14. The method of claim 13, wherein the single input value is received from a user input (UI) element that allows a user to graphically set the operational point of the microgrid.

15. The method of claim 13, wherein the energy resources include one or more of the following: generators, batteries, windmills, and solar panels.

16. The method of claim 13, wherein the operational input data set includes simulated data of operating set points for the microgrid, and the correlating the single input value includes determining a point within the simulated data that corresponds to the single input value.

17. A system, comprising:
a plurality of energy resources for supplying power to a microgrid;
a database comprising simulated data of the microgrid with the microgrid being at a plurality of different control set points for the energy resources; and
a server computer for controlling the plurality of energy resources, the server computer configured to receive a single input value and to correlate the single input value with the simulated data to determine control set points for the energy resources and to set the plurality of energy resources using the determined control set points.

18. The system of claim 17, wherein the single input value is received from a User Interface (UI) element, wherein an operator can manipulate the UI element to set an operational state of the microgrid.

19. The system of claim 17, wherein the energy resources include one or more of the following: generators, batteries, windmills, and solar panels.

20. The system of claim 17, wherein the control set points identify a power output and a droop value for at least one energy resource.
